(19) United States
(12) Patent Application Publication
(10) Pub. No.: US 2009/0157510 A1
(43) Pub. Date: Jun. 18, 2009

(54) Method of Tracking and Redeeming Consumer Carbon Emission Credits

(76) Inventors: Ken Pridmore, Toronto (CA); Fred M. Strong, Montreal (CA)

Correspondence Address: Elias C. Borges, Suite 406, 555 Burnhamthorpe Road, Toronto, ON, M9C 2Y3, CA

(21) Appl. No.: 12/266,865

(22) Filed: Nov. 7, 2008

Related U.S. Application Data
(60) Provisional application No. 60/986,038, filed on Nov. 7, 2007.

(51) Int. Cl. G06Q 30/00

(52) U.S. Cl. 705/14

(57) ABSTRACT

The present invention is an improved method of tracking and redeeming carbon emission credits generated by a plurality of consumers which is economical and practical. The method includes the steps of providing a carbon credits database of carbon emission credits for a plurality of goods and services, said carbon credits database including a list of said goods and services and a list of the carbon emission credits associated with each of the goods and services listed. The method further includes the step of providing a customer loyalty card system to said plurality of consumers, said customer loyalty card system which includes a customer database including a plurality of customer records, each customer record including details of each customer and details of that customer's purchase of goods and services. The method further includes the step of calculating a customer carbon credits total for each customer by summing the carbon emission credits for all of the goods and services purchased by said customer. The method further includes the step of transferring ownership of all of the carbon credits accumulated by the customers' purchase of goods and services to a loyalty card operator, said loyalty card operator operating the carbon credits database and the customer loyalty card system. Lastly, the method further includes the step of providing a customer reward to each of the customers in the customer loyalty card system, said customer reward being proportional to the customer carbon credits total.

### CROSS REFERENCE TO RELATED APPLICATION

This application claims the benefit of U.S. Provisional Patent Application Ser. No. 60/986,038 filed Nov. 7, 2007, the entirety of which is incorporated herein by reference.

### FIELD OF THE INVENTION

The invention relates generally to methods of redeeming carbon emission credits.

### BACKGROUND OF THE INVENTION

Increased large scale CO2 emissions resulting from various industrial and consumer activities such as manufacturing, transportation and the like are generally believed to have a long term detrimental effect on the global environment. The increased levels of CO2 in the atmosphere are believed to increase the “green house” effect whereby the average temperature of the earth slowly increases over time. The gradual increasing of the earths temperature, often referred to as “global warming” has potentially disastrous effects on the global climate, possible resulting in more droughts, an increased frequency in sever weather and a gradual increase in the sea level. As a result of the possibly disastrous consequences of long term climate change caused by increased levels of CO2 into the atmosphere, an international agreement, referred to as the Kyoto Protocol, called for the gradual decrease in the amount of global carbon emissions (i.e. CO2 emissions) by participating nations. To facilitate the implementation of lowered carbon emissions, a system of “carbon trading” is envisioned by the Kyoto Protocol wherein companies that implement a verifiable mechanism for reducing CO2 emissions can sell “carbon credits” to companies who generate CO2 emissions so that the purchasing company can offset the costs of any carbon taxes charged on excess CO2 emissions. Essentially, the trading of carbon credits encourages companies to reduced CO2 emissions by providing them with a mechanism for “selling” their reduced CO2 emissions to others.

While the carbon trading and carbon credit system as outlined in the Kyoto Protocol is a significant step forward in reducing overall carbon emissions, there is considerable paperwork and costs associated with measuring, certifying and selling carbon credits. Because of these difficulties, it is impractical for all but the largest corporations to engage in the trading of carbon credits. As a result, the vast majority of smaller carbon emission producers, such as small companies or individuals, effectively cannot participate in the carbon trading regime.

The current situation is best illustrated in the examination of 4 seemingly unrelated but highly pertinent facts:

Fact #1: People are well aware of ‘Climate Change’ and the urgent need to protect our environment. Accepting or not of the Kyoto Accords, individuals, either voluntarily or motivated by ever-increasing energy prices; want to reduce their personal energy footprint. Governments offer moral persuasions and modest, temporary, inducements for consumers to conserve fossil fuel energy. In fact, individual (residential) carbon based energy consumption has decreased, but only in relative terms. Most people agree that still more could and should be done. And they will support any such effort to that end, particularly one that rewards them for helping.
Fact #2: World statistics indicate that individuals (read; consumers) are the source of more than ⅓ of all GHG emissions. Even if aware of The Kyoto Accords, very few people are familiar with its “Carbon Credit” provisions. Governments, large industrial and commercial entities know of them. And for certain, they will be claiming them. But the same is not true for individuals. Personal emission reductions are being achieved, most likely with more to come. But lack of knowledge, cost prohibitions and intricate red tape make it doubtful that even one consumer will ever claim their legitimately earned “Carbon Offsets”. Millions of tonnes of consumer initiated “Carbon Credits” stand to go unclaimed and un-acknowledged.
Fact #3: Manufacturers are keenly aware of ever-growing consumer demand for more energy efficient products. They have responded by investing millions in product improvements; things like evermore energy efficient: light bulbs, windows & doors, household appliances, automobiles, etc. But the specific message of any single energy efficient producer is being lost in all the green marketing ‘noise’ of both its competitors and non-competitors alike. The fact is that millions of invested dollars are at risk. Each such manufacturer seeks better ways to raise its particular product above the advertising ‘din’ of all the other ‘Green Marketers’.
Fact #4: All corporations, even those unrelated to energy production, conservation or efficiency, seek to ‘appear green’ to their clientele. An environment friendly corporate image is a key goal of practically every organization. They know that when it comes to image, it's a matter of “A green-guy equals a good-guy”. It's hard to think of any business that doesn't want to add effective ‘Green Appeal’ to its consumer corporate image.

An improved carbon trading system which makes it possible for smaller carbon emitters to participate in carbon credit trading is therefore desirable.

### SUMMARY OF THE INVENTION

The present invention is directed at providing a cost effective method of tracking and redeeming carbon emission credits generated by a plurality of consumers. The method includes the steps of providing a carbon credits database of carbon emission credits for a plurality of goods and services, said carbon credits database including a list of said goods and services and a list of the carbon emission credits associated with each of the goods and services listed. The method further includes the step of providing a customer loyalty card system to said plurality of consumers, said customer loyalty card system comprising a customer database including a plurality of customer records, each customer record including details of each customer and details of that customer's purchase of goods and services. The method further includes the step of calculating a customer carbon credits total for each customer by summing the carbon emission credits for all of the goods and services purchased by said customer. The method further includes the step of transferring ownership of all of the carbon credits accumulated by the customers' purchase of goods and services to a loyalty card operator, said loyalty card operator operating the carbon credits database and the customer loyalty card system. The method further includes the step of providing a customer reward to each of the customers in the customer loyalty card system, said customer reward being proportional to the customer carbon credits total.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### BRIEF DESCRIPTION OF THE DRAWINGS

FIG. 1 is a schematic view of the system of the invention showing how the process produced benefits flow among the participants of the system namely the host nation, the regulators, the green card issuer, the green card sponsor, the green card holder and the environment.

FIG. 2 is a schematic view of a portion of FIG. 1 showing only the flow of benefits prior to the present invention.

FIG. 3 is a schematic view of a portion of FIG. 1 showing benefits flowing from the green card issuer to the green card holder.

FIG. 4 is a schematic view of a portion of FIG. 1 showing benefits flowing between the green card issuer and the green card holder.

FIG. 5 is a schematic view of a portion of FIG. 1 showing benefits flowing between the green card issuer and the green card holder and also showing the flow of benefits from the green card issuer to the green card sponsor.

FIG. 6 is a schematic view of a portion of FIG. 1 showing benefits flowing between the green card issuer and the green card holder and also showing the flow of benefits between the green card issuer and the green card sponsor.

FIG. 7 is a schematic view as in FIG. 6 above also showing the flow of benefits from the green card sponsor to the green card holder.

FIG. 8 is a schematic view as in FIG. 6 above also showing the flow of benefits between the green card sponsor and the green card holder.

FIG. 9 is a schematic view as in FIG. 8 above also showing the benefits from the green card holder, green card sponsor and green card issuer to the environment.

FIG. 10 is a schematic view as in FIG. 9 above also showing the flow of benefits to the host nation from the green card issuer.

FIG. 11 is a schematic view as in FIG. 9 above also showing the flow of benefits between the host nation and the green card issuer.

FIG. 12 is a schematic view as in FIG. 11 above also showing the flow of additional market motivated benefits between the green card holder and the green card sponsor.

FIG. 13 is a schematic view as in FIG. 12 above also showing the flow of benefits from the green card holder to the host nation.

FIG. 14 is a schematic view as in FIG. 13 above also showing the flow of benefits from the host nation to the regulators and to the environment.

FIG. 15 is a schematic view as in FIG. 14 above also showing the flow of benefits from the regulators to the green card issuer.

FIG. 18 is a schematic representation of the database structure used in the system of the present invention, namely the main green card database, sub-base 1, sub-base 2 and sub-base 3.

FIG. 19 is a schematic representation illustrating how sub-base 3 can be compiled by accessing various databases belonging to regulatory bodies, certifications centres and carbon credit brokerages.

FIG. 20 is a schematic representation illustrating a sample transaction using the system of the present invention.

FIG. 40 is a schematic representation illustrating another sample transaction using the system of the present invention.

FIG. 60 is a schematic representation illustrating yet another sample transaction using the system of the present invention.

FIG. 80 is a schematic representation illustrating still another sample transaction using the system of the present invention.

FIG. 100 is a schematic representation showing the sponsor structure for the green card system.

In the drawings like characters of reference indicate corresponding parts in the different figures.

### DETAILED DESCRIPTION OF THE INVENTION

The process for patent addresses each and every need, apparent or implied, cited in the background section above. It does so simply, quickly and effectively; all at the same time. It stimulates widespread and dramatic improved reductions in Personal/Individual sector GHG emissions, much for the relief of our fragile environment. Plus, Green Card (GC) rewards both consumer and sponsor for their part in those reductions, thus ensuring their mutual, ongoing participation in the process, so as to continue to reduce emissions in that sector.

Green Card (GC) is consumer loyalty & incentive plan, not unlike Air Miles (or Aeroplan®, but with a differentiating environmental theme; namely to mitigate Climate Change. The Green Card Concept (GCC) unites cardholders, card sponsors, card issuer, the host nation and its environmental regulators in a symbiotic relationship designed to reduce GHG emissions in the Individual/Personal sector of the economy. The biggest beneficiary of the process is the environment itself, which thus becomes the sixth participant in the concept. It is relieved, at first of hundreds of thousands and soon millions of tones of harmful carbon (CO2) emissions.

Green Card is different things to different people. To Cardholder it's a generous point-promotion, even for non-green purchases; but even more so for “green” purchases. To Card Sponsor it's an extremely effective customer loyalty and incentive plan; plus a huge corporate eco-image enhancer. To Card Issuer it's a self-financing way to encourage and increase eco-friendly consumer behavior. To Host Nation it's a means to identify formerly unacknowledged carbon credits; to help meet international treaty obligations, plus conserve strategic fossil fuel resources. To Regulators, it makes their job easier and more effective.

Green Card Concept (GCC) allows both individuals and small to medium sized businesses to benefit from the carbon credit provisions of the Kyoto Accords; something only very large corporations have been able to do in the past.

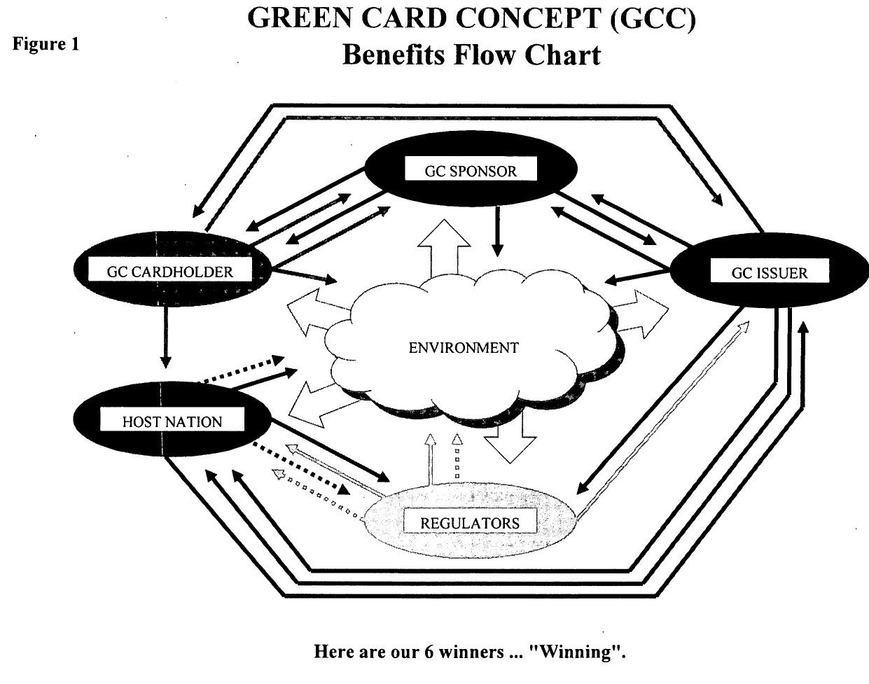

As the Benefits Flow Chart (FIG. 1) shows, all 6 of the above named participants in the process are winners. But Environment is the biggest winner.

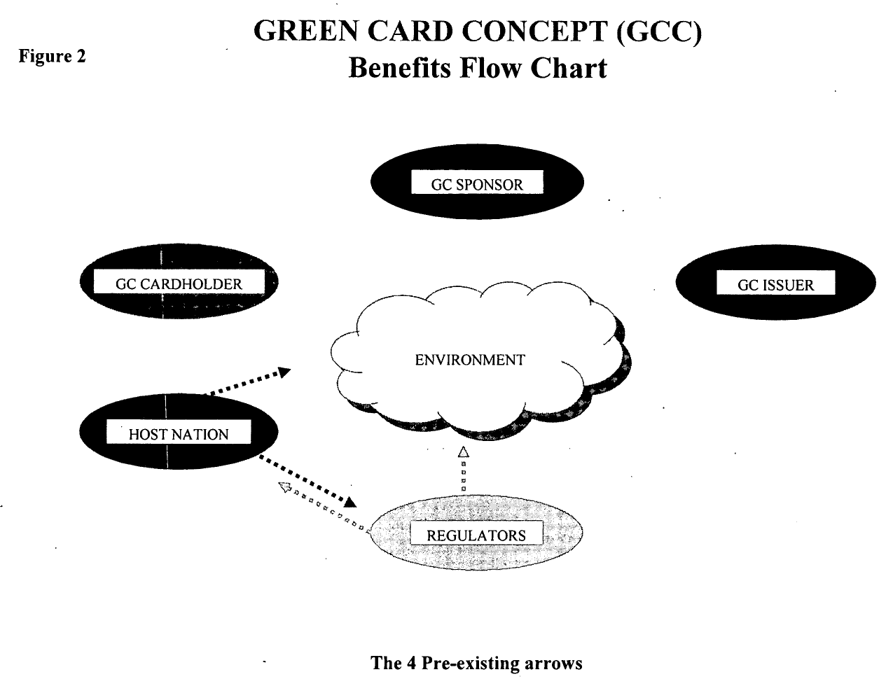

FIG. 1: Is a schematic of how the benefits of GCC flow among the participants. Most often, benefits flow both ways between players; thus justifying the earlier use of the word “symbiotic”. The caption is: “A picture of our 6 winners; winning.” That's because there are no losers in the GC process. Each solid arrow represents a “win” that would not occur without GCC. Some benefits (“wins”) are quite obvious. They receive little explanation below; others require more. The progression of figures (FIG. 2 through 17) combined with the following descriptions, will re-build the original chart in stages, to provide the reader a better understanding.

FIG. 2: This shows the 4 pre-existing arrows (broken) prior to Green Card. All subsequent arrows (solid) are courtesy of the Green Card Concept (GCC).

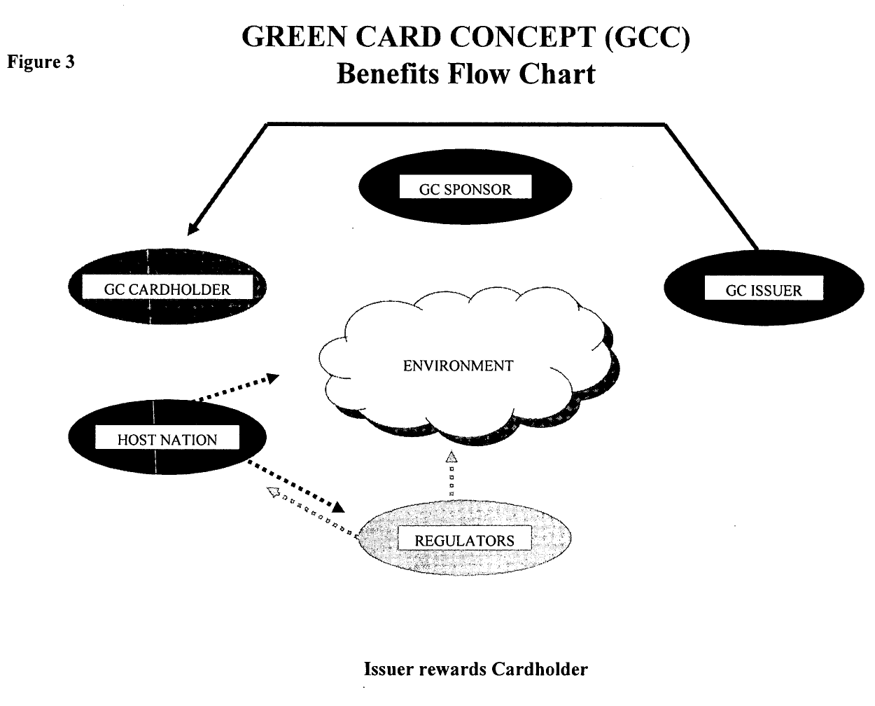

FIG. 3: GC is a consumer held card that rewards Cardholder for environmentally friendly purchases, and thus encourages their continued eco-friendly shopping; a benefit. Rewards are in the form of “points”, valued towards various selections by Cardholder of goods &/or services from the Green Card Rewards Catalogue. Points are awarded in three (3) ways. The first is from the retail sponsor and is usually proportioned by that sponsor according the value of the purchase. These we call “green points 1”, be the purchase “green” or not. (This first award is similar to most other consumer “point-promotions”.) However, an eco-friendly purchase of a GC Sponsored product receives additional reward points; we call “green points 2”, directly from that second sponsor. (The second award may be related to purchase value too.) Finally, there is likely a third award forthcoming for the same eco-friendly purchase, but this time from the Card Issuer. We call those “green points 3”. Not only are the second and third awards unheard of in existing plans, in the case of “green points 3”, the award is not proportional to the purchase value but rather, proportional to the derived benefit to the environment of the specific purchase made.

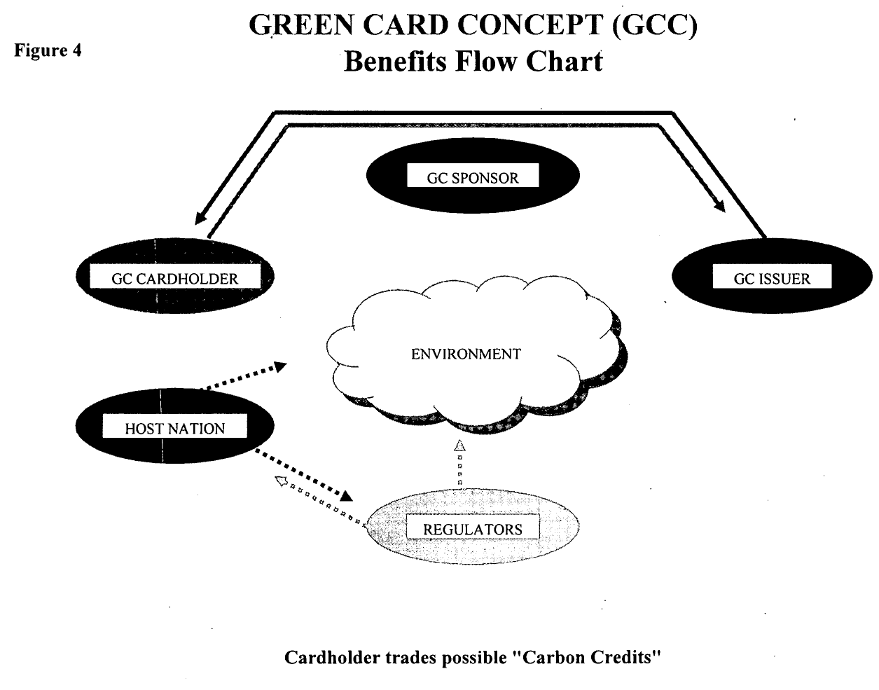

FIG. 4: In return, Cardholder trades any “possible” resultant carbon credits; a benefit. In effect, Cardholder cedes their ownership to Card Issuer. This is a key process point because “proof of ownership” is the first in a long series of requirements toward the eventual converting of those “possible” carbon credits into marketable Certified Emission Reductions (CER). But the important first consideration is why Cardholder “wins” by trading away ownership. The answer is: they are trading something of no value to them (See “Fact 2” in Background section) for something of real and current value; namely the “green points 3” offered by Issuer.

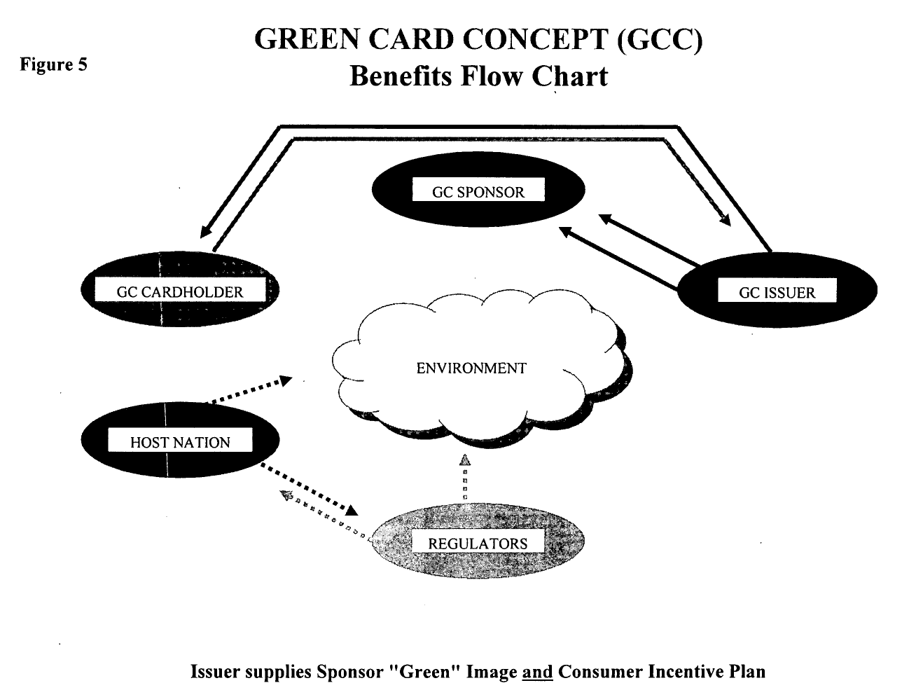

FIG. 5: Issuer supplies Sponsor a highly visible “Green Image” and a very effective Consumer Loyalty & Incentive Plan; 2 wins; 2 benefits. (See “Facts 3 & 4” in background section.)

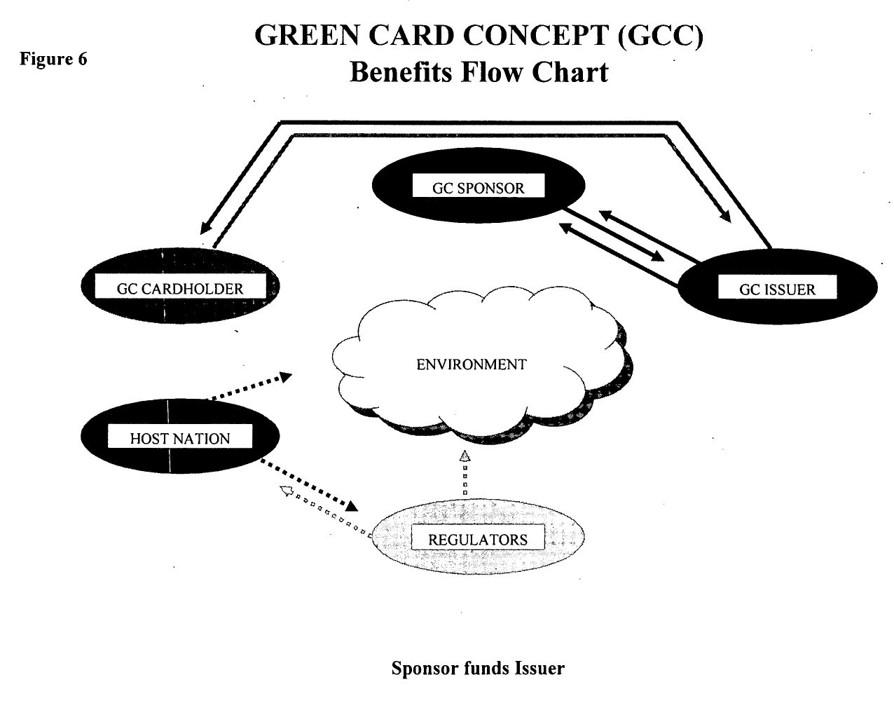

FIG. 6: In return, Sponsor funds Issuer via sponsor fees and purchases of “points”; a benefit.

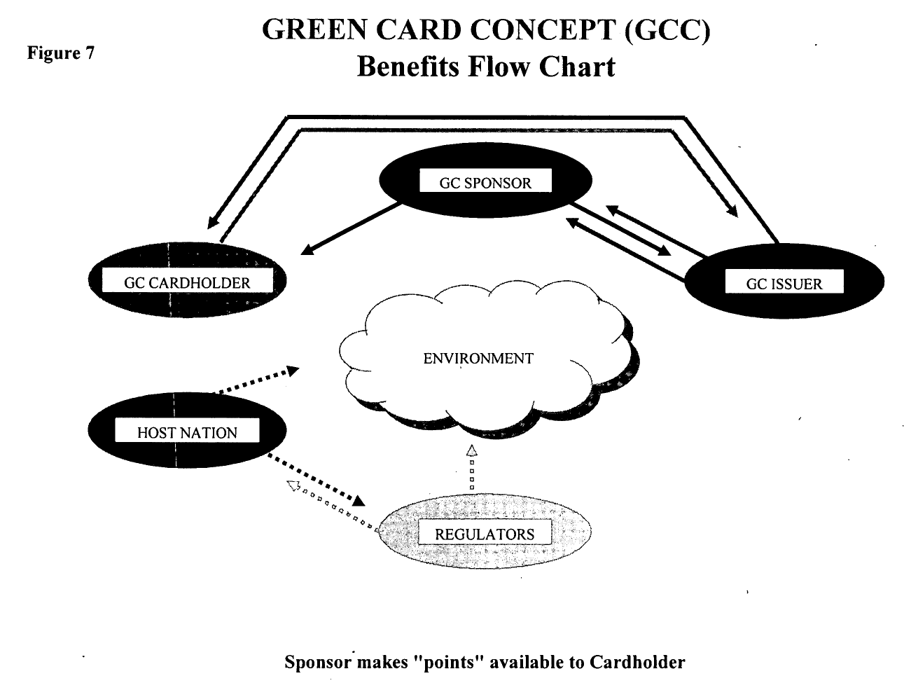

FIG. 7: Sponsor makes those “points” available to Cardholder; a benefit.

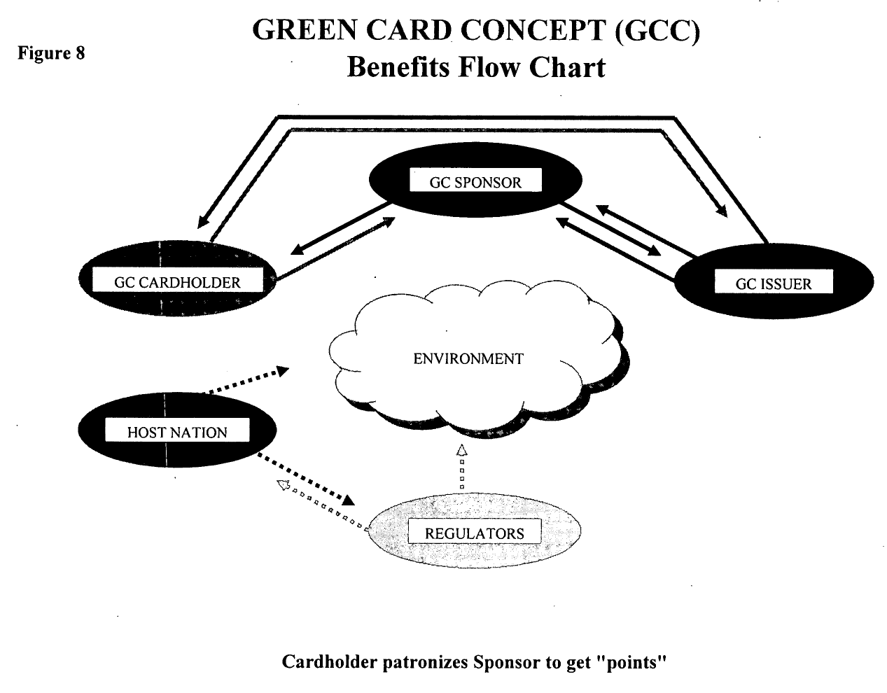

FIG. 8: To get those “points”, Cardholder patronizes Sponsor; a benefit.

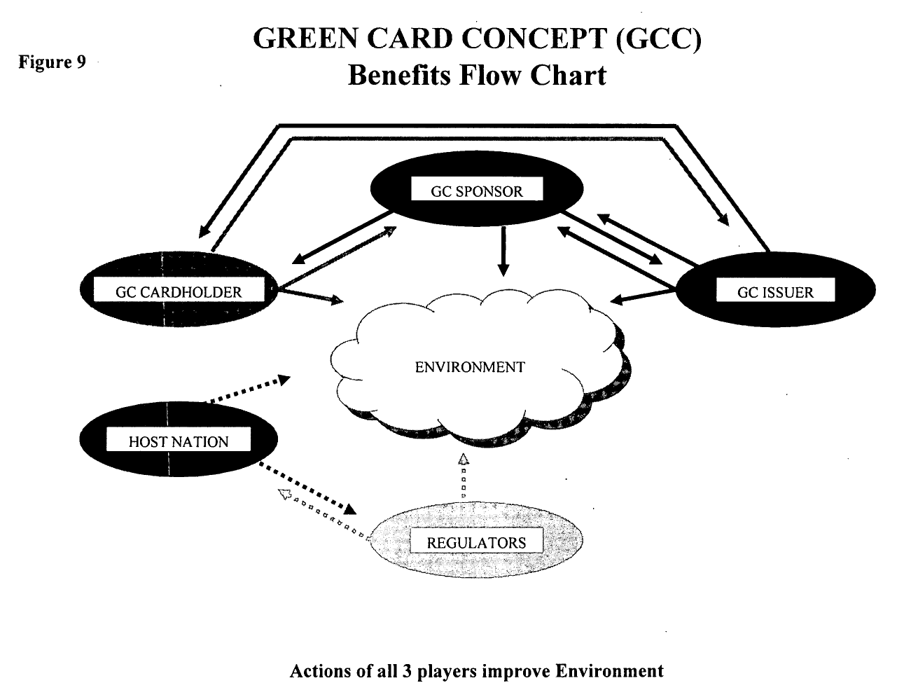

FIG. 9: The described actions of Cardholder, Sponsor and Issuer combine to significantly reduce GHG emissions and thus improve the Environment; so 3 more benefits.

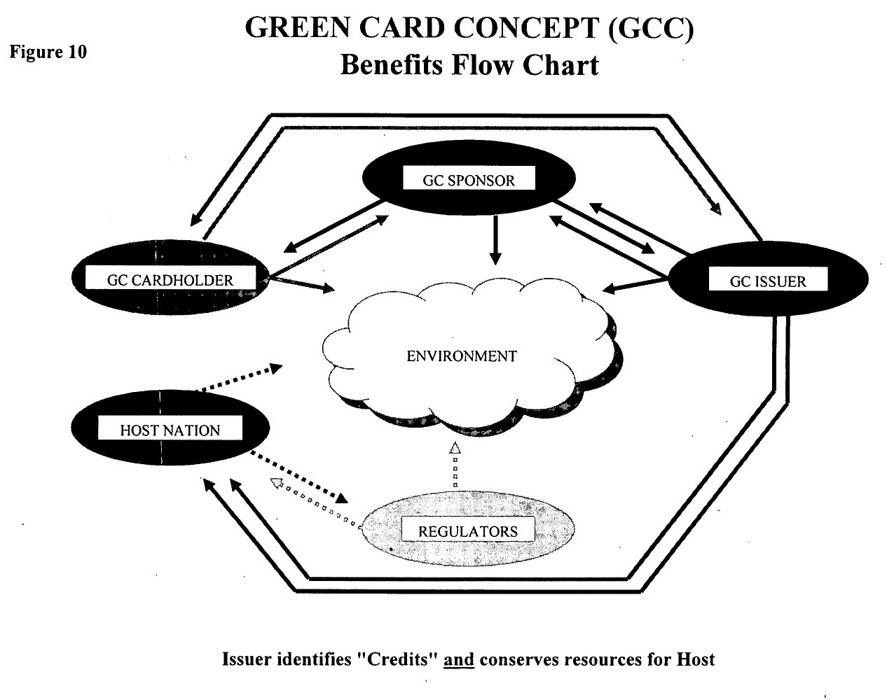

FIG. 10: To get this far, Issuer identified “possible” carbon credits that would otherwise go un-acknowledged for Host Nation. National Climate Change Objectives become more attainable. Plus there is conservation of fossil fuels; a strategic resource. Host wins twice; so 2 benefits.

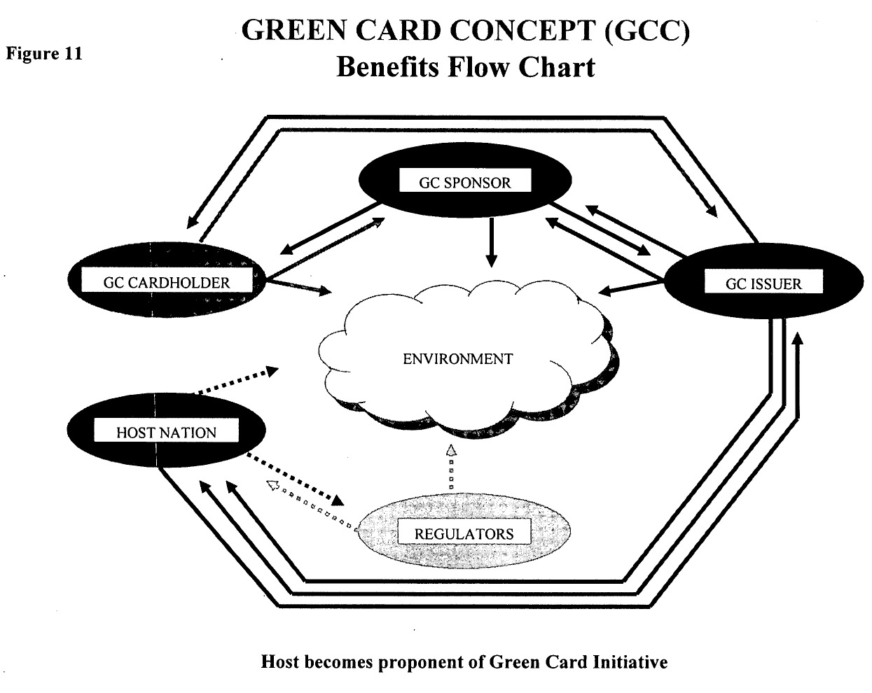

FIG. 11: Thus Host becomes a proponent of the GC initiative; a benefit back.

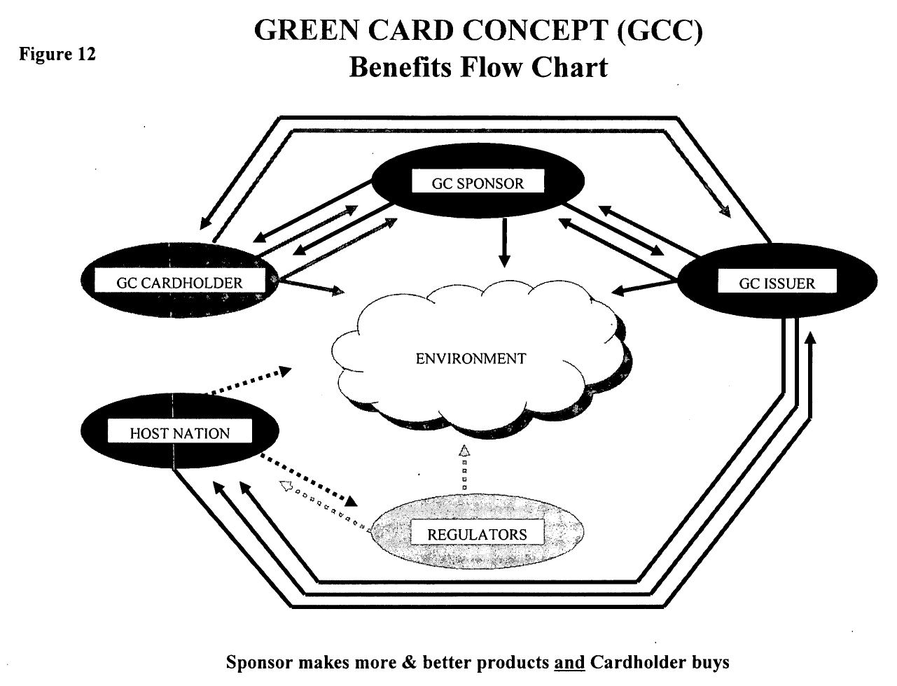

FIG. 12: Meanwhile, makers of energy efficient products, many of them GC Sponsors anyway, are market-motivated to R&D and to produce more and further improved products. That means more and better goods for Cardholder to buy. That's a pair of benefits, back and forth, plus renewed benefits to all players; particularly to Environment. Here's where GC shows its “snowball effect”, but we don't even try to repeat all those benefits; just the new, originating one.

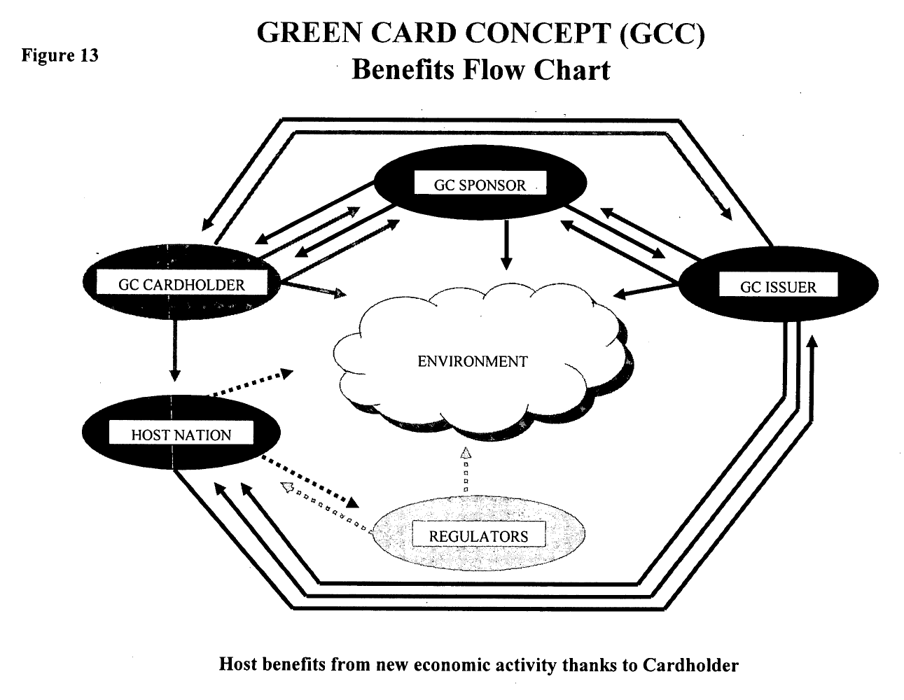

FIG. 13: Host gains most from all this new economic activity; so from Cardholder to Host; a benefit.

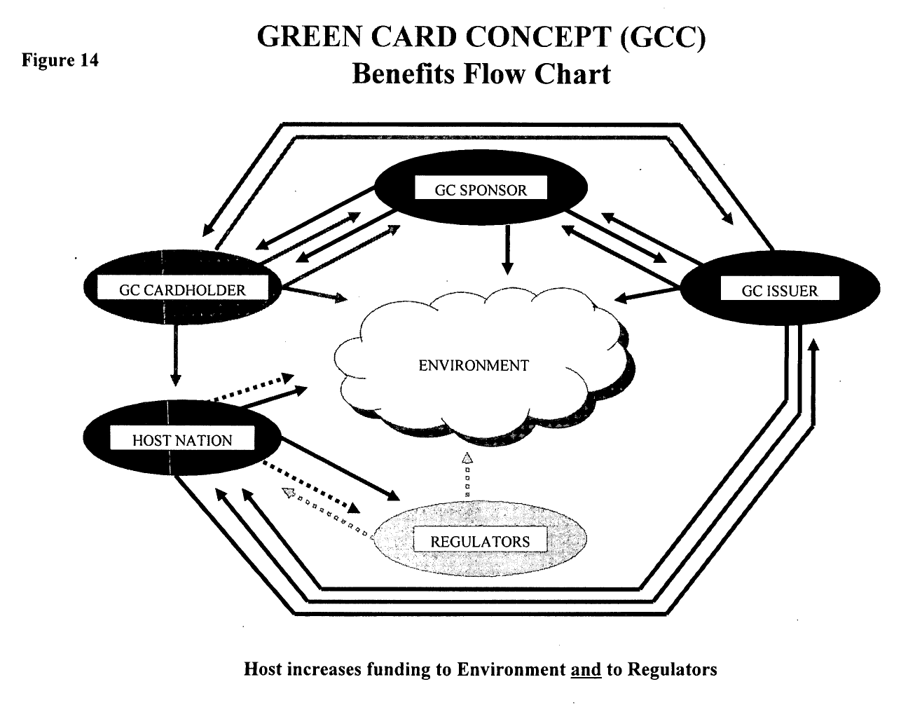

FIG. 14: Inevitably, some of the new revenues to Host will go back into more funding; to Environment and to Regulators; 2 more benefits.

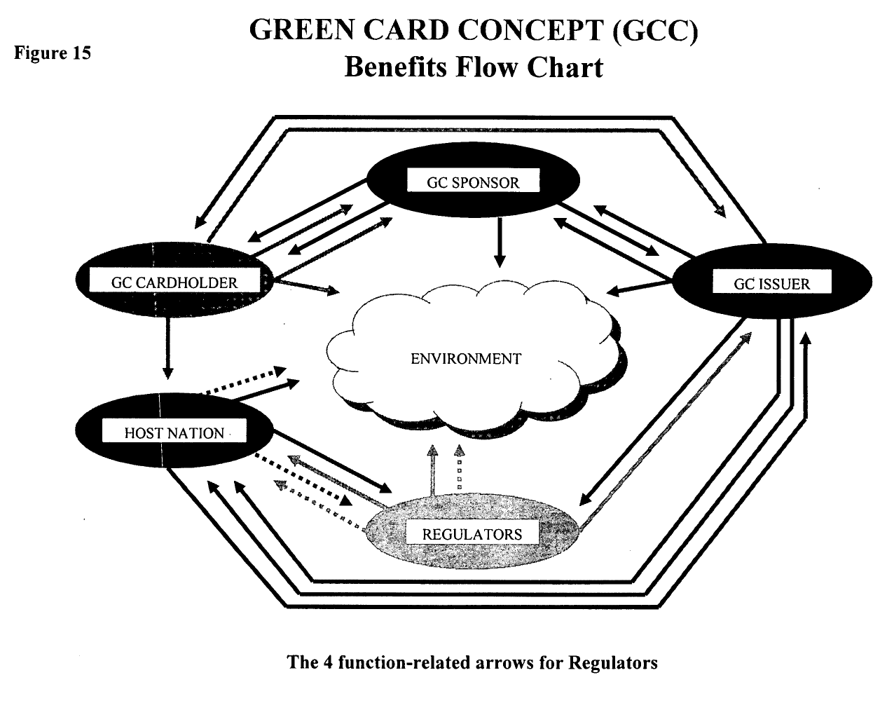

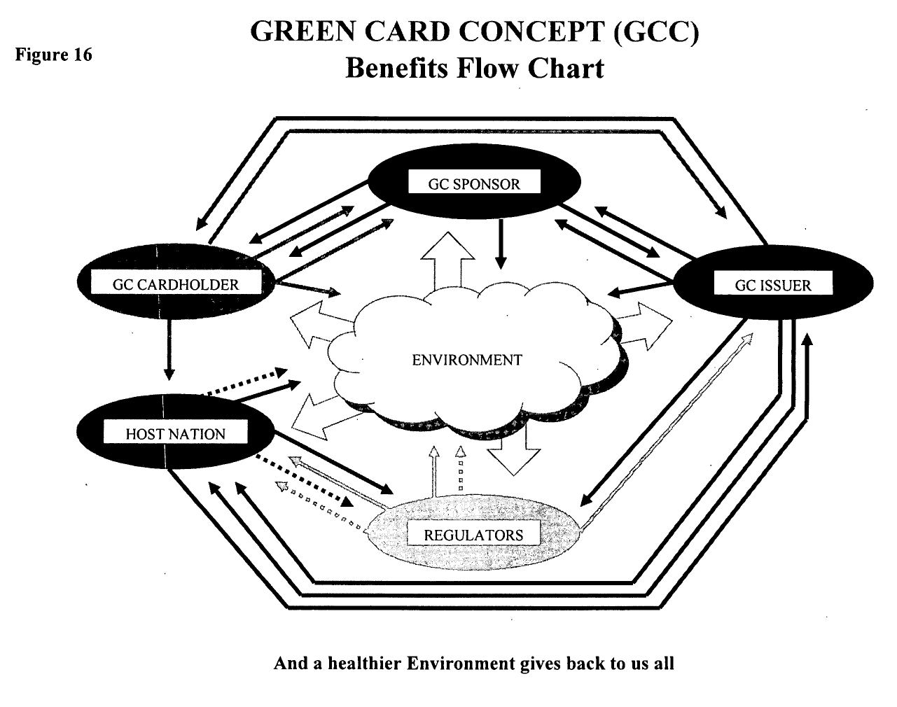

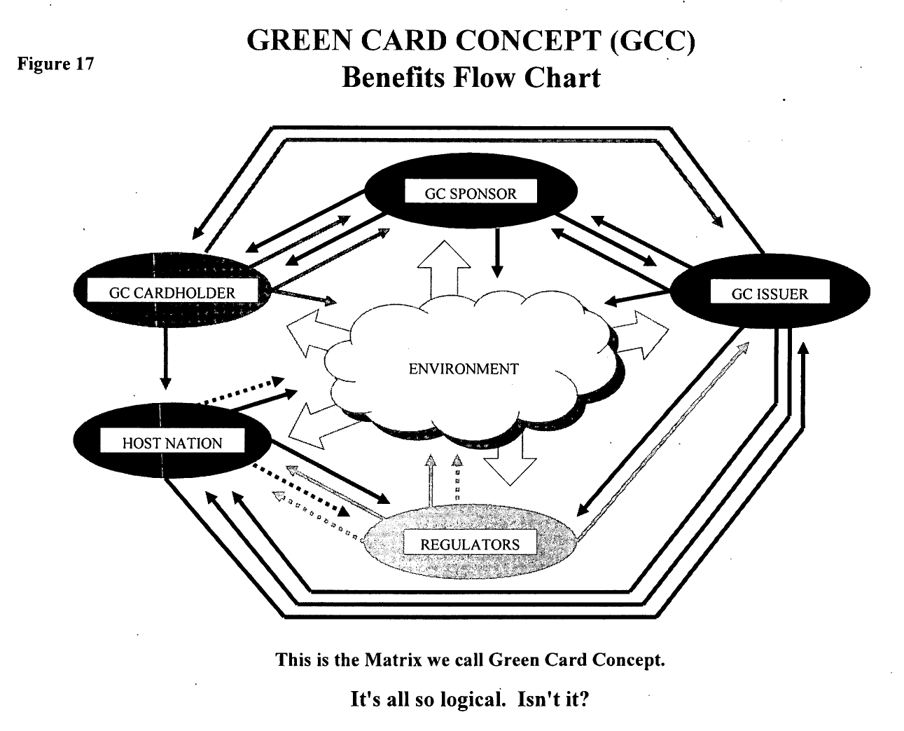

FIG. 15: And now that they're officially in the GC winners' circle, Regulators get their 4 function-related benefits too.

FIG. 16: So, everyone wins. But the obvious winner is Environment. It is relieved of hundreds of thousands, soon millions of tonnes of harmful GHG emissions. And a better Environment gives back to all of us. So, here are the final 5 (broad arrows) benefits to the schematic.

FIG. 17: This is the Matrix called “Green Card Concept”. You saw it before, but it should make more sense now. In fact: It's all so logical; isn't it?

### In Summary:

The key process component is the card itself. Originally we called it “The Carbon Credit Card”. We chose that name originally because: it contains both of the 2-word phrases that best describe two major parts of the GC process “Carbon Card” and “Carbon Credit”.
The first role is to reduce carbon emissions. The second is to identify “possible” carbon credits (as defined by Kyoto) that would otherwise go unclaimed.
Green Card defined: GC is a consumer held card, which calculates and accumulates the “Carbon Credits” that result from an individual consumer's purchase and continued use of ever more energy efficient products. In exchange for those credits, Card Issuer gives Cardholder extra ‘green points’ towards the purchase of a wide variety of products and services. Corporate Sponsors enlisted in the GC Process, make those ‘green points’ available.
Cardholder wins because he/she gets something of value for surrendering something of no-value to them. Card Issuer wins because he gains the accumulated “Carbon Credits” of hundreds of thousands of conscientious consumers; later to be sold to fund what will then become the most generous consumer rewards programme in the marketplace. Sponsor wins because he gets the “Green-Guy” image he seeks &/or a timely, efficient, effective and ongoing customer loyalty & incentive plan. So far, all 3 players win. And the other 3 winners soon emerge.

### Results of GC Process Implementation (3 Views):

1. The Micro View: When and wherever implemented, the GC Process will reward, and thus increase, the environmentally friendly purchases of consumers already committed to “green” purchasing. It will also lure ‘fence-sitter’ consumers to the “green” side. It may even convert some previously un-convertible consumers to go “green”. (Personal gain is a proven motivator.) Additionally, it will reward past R&D efforts of manufacturers of energy efficient products with improved current sales. Also, via the same marketplace, it will encourage continued efficiency improvements in both those manufactures and their competitors. It may even commit previously uncommitted manufacturers to develop & market new, even more efficient products.

The progressive micro effects are quite predictable: first, purchasers of energy efficient products are rewarded and more green purchasers are created; then, manufacturers of energy efficient products are rewarded and more green manufacturers are created; resulting in more energy efficient products being produced for that ever growing number of green product purchasers. And so, the GC “reward snowball” (see FIG. 12 discussion above) continues to roll, to grow and to gain momentum. In the end, overall individual GHG emissions are significantly reduced; producing the 4th ‘Winner’ from the process; the environment itself.

2. The Macro View: When and wherever implemented, the GC Process will have a positive effect upon improving the environmental impact of the host nation on ‘global warming’. From ½ to as much as Y of a country's total GHG emissions come from individuals; their families, houses, cars, etc. Currently, not enough is being done constructively and on an ongoing basis, to reduce the environment damaging emissions of this significant economic segment. Any nation's effort to reduce its total GHG emissions need better address this huge segment if ever to be successful.

An added benefit to Host of GC Process comes from the authoritative recognition of otherwise unidentified Carbon Offsets. These previously unclaimed “Credits” will be valuable contributors towards Host Nation's international treaty obligations. Finally, allowing any continued, unnecessary consumer dependence on its dwindling national fossil fuel reserves is against any country's long term strategic interests. So Host Nation becomes the 5th GC Process ‘Winner’.

The Micro to Macro Transition: Imagine: first tens of thousands; then hundreds of thousands; then millions; then hundreds of millions of environmentally conscientious consumers, each reducing their annual individual GHG emissions by an additional tonne, or even a half a tonne. The resulting impact on Climate Change is spectacular. You may well ask: Will the proposed GC reward/incentive process alone, save the planet? The answer is: “Likely not”. But then ask yourself: Can we save the planet without something like the GC Process? Again the answer is: “Likely not”.

### Mechanics of the Process:

Above it is stated that the “Green Card” itself, is the key component of the process. But the KEY ENABLER of the process is its carefully designed database(s). In a way, there will be 3: The first database is dedicated to the cardholders and everything about them; their membership info, their qualified ‘green’ purchases, their rewards balance, their redemptions, their referrals, etc.

The second database is dedicated to the sponsors and everything to do with them; their Agreement (Rights, Privileges & Obligations), their contact info, their Advertising & Promotion structure with all its outside associations, their qualifying product/service codes (each with its own relative efficiency specification), their points purchase & redemption records, etc. The third database is dedicated to the acquired “Carbon Credits”; their calculation & its methodology, their regulatory coordination, their Authentication, Verification & Certification, their accumulation and disposition, etc. Although described here, and actually administered, as 3 separate databases, what is developed in fact is a single, highly specialized database with 3 distinct input sources and function areas.

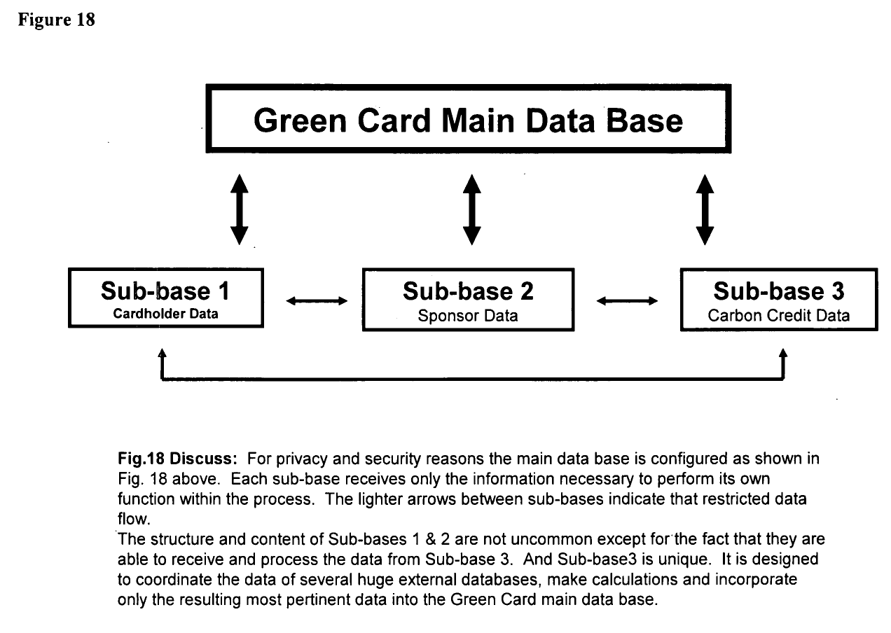

### As for FIG. 18:

For privacy and security reasons the main data base is configured as shown in FIG. 18. There are several reasons for this configuration. One is “privacy”; a serious concern for Cardholder, Sponsor and Issuer alike. Provision is made for individual cardholders and individual sponsors to be able to access their own account information but only them, and only their own info. Similarly, “security” is a major concern for all, but particularly for Issuer. Therefore, each sub-base receives only the information that is absolutely necessary for it to perform its own function within the process. (The lighter, thinner arrows between sub-bases attempt to show that “security-restricted” data flow.)

It is important that FIG. 18 differentiates between the functions of the 3 sub-bases. The structure and content of Sub-bases 1 & 2 are not uncommon except for the fact that they are able to interface with, and process the data from Sub-base 3. And it's Sub-base 3 that is unique. Sub-base 3 is designed to access, retrieve and coordinate the data of several huge external databases; to make calculations and to incorporate only the resulting most pertinent data into the GC main database. As mentioned, this key process capability is called: “The Process Enabler”.

### Database Discussion:

Other than being highly expandable, the structure and functions of sub-bases 1 & 2 are not particularly remarkable. The required computing power and record keeping is straight forward and not beyond ready understanding. (Existing consumer loyalty & incentive plans are doing similar right now.) However, sub-base #3 is another case entirely. It too must be highly expandable but the specialized nature, composition, content and capabilities of this sub-base are central to the GC Process. To demonstrate the special processes involved we need but one example.

### EXAMPLE A

Let's assume a GC member, say a resident of Ontario, buys a compact florescent light bulb to replace a 40W incandescent bulb in his hallway. Input from the florescent manufacturer states comparable light comes from their 11W florescent. That's a 72.5% efficiency improvement.

So, are emissions cut by 72.5%? No. Sub-base #3 also knows the typical proportion of Ontario electricity that is produced from fossil fuels, and even which types of fuels they are. (Remember: electricity generated by nuclear, wind and water doesn't cause CO2 emissions.)
So #3 just multiplies 72.5% by the fossil fuel component of the local utility and that's the answer, right? No.

The burning of different fossil fuels release different products of combustion with different effects on the environment. There are accepted formulae that establish CO2 equivalents (CO2e) for the most common emissions of fossil fuels other than CO2. In effect, CO2e becomes the common denominator for all GHG emissions. For instance, the nitrites and sulfites in oil and coal are deemed much more damaging to the environment than just the CO2 that's released in exactly the same combustion. Therefore, 1 tonne of nitrous emission is said to be “equal to” some 20 tonnes of CO2.

OK, that means maybe two more calculations, right? Yes, at the very least two more, depending on the significance, proportions and toxicity of the associated emissions. Many calculations later, we might estimate that this particular florescent bulb reduced annual emissions by 0.00000000123 of a tonne of CO2e. (This figure is a guesstimate only for the purposes of this example. But sub-base #3 could calculate it accurately to 50 or even 100 decimal places.)

And what's more, once done, #3 would remember that exact figure for whenever another member made a similar purchase. (Thankfully, there are several million light bulbs sold each year; a fact that turns all those decimal places into a potentially significant contributor to GC carbon credit accumulations and thus, makes light bulbs worth the data processing effort.) Obviously manual calculations would be useless and in such situations, even using “typical” and “average” numbers as inputs. It's the number crunching of sub-base #3 that makes the whole GC Process possible. And this illustrates a crux of the GC Process. The trick to making it work is using only the “typical & average” numbers acceptable to the regulatory authorities of whichever Host Nation in which the GC Process functions at the time. Therefore, all such number inputs into sub-base #3 are carefully selected and documented. The goal is that the number of carbon credits, CER's actually, eventually claimed is almost ‘pre-approved’. Be assured, this too can be done; it's just a matter of exactly HOW and WHERE those “typical & average” numbers are used & sourced.

### FIG. 18: Significance Discussion:

FIG. 18 shows the configuration of the main data base. It includes the 3 sub-bases and is called “The Process Enabler”. Descriptions and examples that follow emphasize the crucial role of sub-base #3 in the whole process.

Clearly, identifying “possible” carbon credits (and quantifying them properly) is a central and complex component of the process. Done routinely and accurately, it initiates the most desirable feature of the method but also its major, burdensome requirement.

The desirable feature is the awarding of the tertiary “green points 3” to Cardholder exactly proportional to the benefit derived to the environment of any specific eco-purchase. In the case of the GC Process, the rule book to achieve that proportionality lies in the Kyoto Accords (&/or whatever international agreement that might eventually replace them). In particular, it is Kyoto's definitions of what is, or is not a “Carbon Credit” and how it is quantified that becomes the measure to fulfill our “proportional” promise to both Cardholder and Sponsor.

It is the assurance of “proportional” rewards that gives the GC Process its “Deep Green” theme and proof of GC's sincerely green motivations. With private, public and corporate concern about Climate Change at all time high levels, it's this “sincerely green” feature that will propel our solicitations of both Cardholders and Sponsors; the only two participants that are invited to play ‘The Green Card Game’. (The other 4 are already, fully committed.)

The accumulation and eventual sale of “possible” carbon credits ceded by Cardholder to Issuer is a crucial financial pillar of the method. The eventual extra revenues from their sales will let the GC rewards be the most generous in the industry. In turn, that will attract the largest number of cardholders; leading to the biggest overall reduction in emissions; creating the greatest benefit to the environment and the maximum mitigating effect on Climate Change; our ultimate goal.

But as suggested, the “proportionality” feature also necessitates some major requirements of the GC method. Setting-up and administering sub-base #3 is expensive in time, money and effort; but absolutely necessary. Remember: A “possible” carbon credit is worthless. Only in its successful conversion to a CER does it gain value. And moving from a “possible” carbon credit to a CER is complicated, time-consuming and once again, very expensive in resources. To paraphrase it, the establishment and maintenance of the intensively detailed requirements of sub-base #3 is an Evil Necessity to reach a Greater “green” Good.

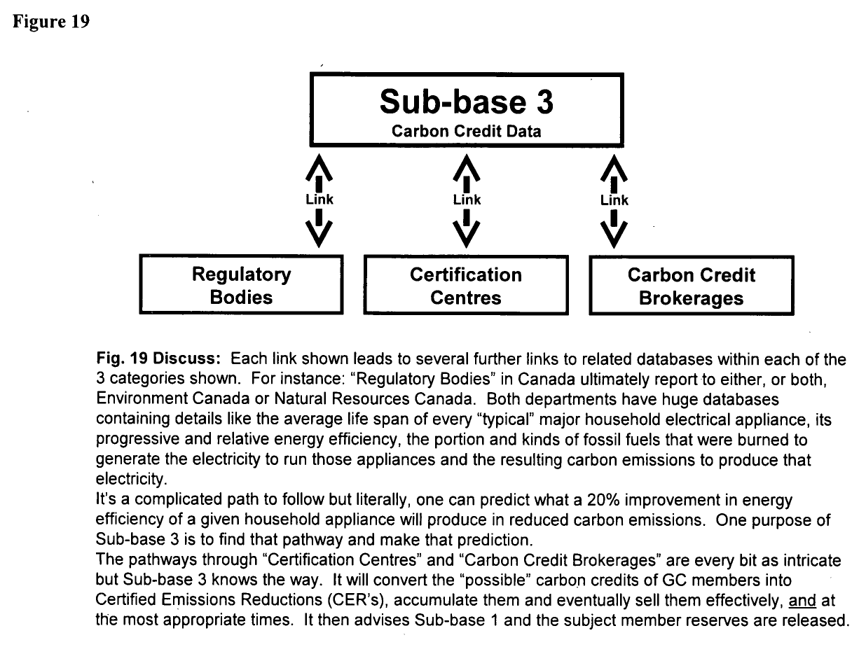

Proportionality, achieved via identification and conversion of “possible” carbon credits to CER's, is possibly the most important and unique feature of the entire Green Card Process. Accordingly, FIG. 19 clarifies this crucial role of Sub-base 3.

### As for FIG. 19:

The 3 links shown are only the first of several subsequent links related to numerous databases within each of the 3 categories provided. For instance in Canada, “Regulatory Bodies” ultimately report to either or both Environment Canada and Natural Resources Canada. Both of these departments have huge databases drawn from several credible sources.

These 2 databases contain details like the average life span of every “typical” household electrical appliance, its progressive and relative energy efficiency, the portion and kinds of fossil fuels that were burned to generate the local electricity to run those same appliances and the resulting carbon emissions to produce that electricity. Further, all the relative numbers are annualized; in the case of NRCan, for more than the past 2 decades. Therefore, “on average” one can predict exactly what a 20% improvement in the efficiency of a given household appliance will produce in reduced carbon emissions. Granted, it's a very complicated and intricate path to find and to follow (see Example A). So one goal of Sub-base 3 is to find that pathway and make that prediction for each ‘green purchase’ of GC members.

Likewise, the pathways and links through “Certification Centres” which deal with compliance issues like authentication, calculation methodology and third party verification are every bit as intricate. It's a lengthy trip but Sub-base 3 knows the shortest path to convert a “possible” carbon credit into a CER; the only commodity that is actually sold in what people still call; ‘the carbon credit market’.

Before this discussion leaves “Certification Centres”, an important fact must be reiterated. Part of the authentication of “possible” carbon credits is “Proof of Ownership.” For GC to be able to “Certify” them in order to be able then to sell them, even on behalf of its members, GC must be able to prove its ownership. That is why, the GC Membership Terms clearly state that Cardholder trades (cedes) ownership of any possible resultant carbon credits to Issuer, in return for the offered extra award points. (We know of no other consumer loyalty & incentive plan with such a membership stipulation.)

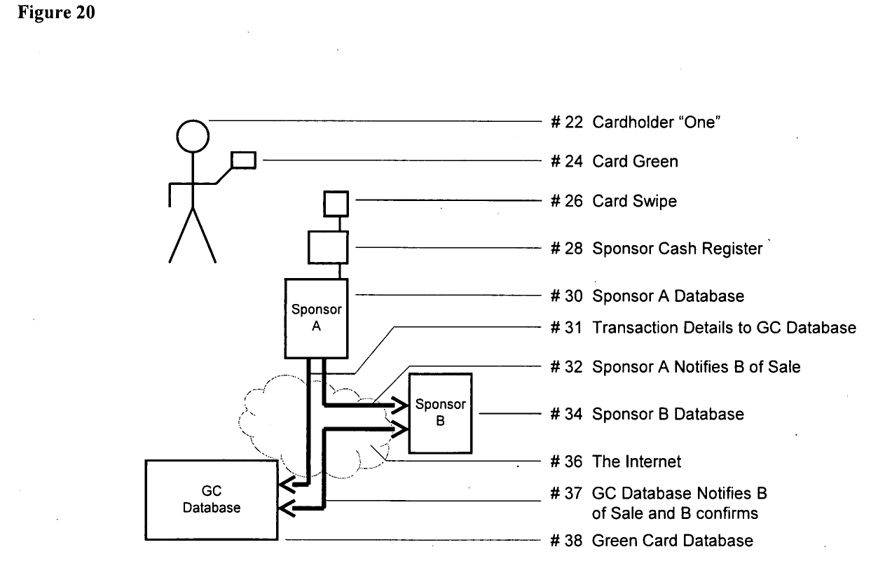

For the next step in the process illustrated in FIG. 19, Sub-base 3 will combine and accumulate the CER's of all member cardholders, and with its many links to and through several “Carbon Credit Brokerages”, it will recommend the best amounts and most effective times to sell them in the open market, anywhere in the world. And finally, once all this is done, Sub-base 3 will so advise Sub-base 1 and the appropriate, subject member reserves will be released. (More on this last point follows in the transaction examples, starting with FIG. 20.)

### As for FIG. 20: (Transaction Example One)

Cardholder “One” (#22) is an individual shopping at GC Sponsor “A”; a chain, mass merchandiser. “One” buys clothes, groceries and household items including a pack of 6 compact florescent light bulbs. The compact florescent light bulbs are manufactured by GC Sponsor “B”.

At Sponsor “A” cash register (#28), “One” swipes (#26) their Green Card (#24) which identifies them as a GC “points” collector. All pertinent transaction data (#31) is sent via the internet (#36) from the Sponsor “A” database (#30) to the GC database (#38). “Green points 1”, as set out by Sponsor “A”, at their discretion but usually proportional to purchase values, are calculated and immediately accorded (credit/debit) to the accounts of both “One” and Sponsor “A”.

The GC database recognizes the compact florescent light bulbs, manufactured by Sponsor “B”, as an eco-friendly purchase mitigating Climate Change. Sponsor “B” database (#34) is notified of the sale, also via the internet, by both Sponsor “A” (#32) and GC database (#37) and Sponsor “B” confirms the notification back to GC Database (#38).

Additional points (“green points 2”) as set out by Sponsor “B”, are appropriately accorded (credit/debit) to both Cardholder “One” and Sponsor “B”; also instantaneously.

Then, GC database (#38) calculates the impact of those compact bulbs on reduced carbon emissions, measured in CO2e as defined in the Kyoto Accords. Proportional to those “possible” carbon credits, “One” is accorded still more points (“green points 3”). But these points are held in reserve along with those of all other GC Cardholders. All such “possible” carbon credits are accumulated in a single “membership pool” until it is economically practical to convert them from “possible” to “Certified” carbon credits; eligible for sale in the open market.

When such a sale is successfully completed, the “green points 3” are released from reserve, and made available for “One” to redeem at his/her convenience. All 3 types of points will purchase goods and/or services as described and illustrated in the Green Card Rewards Catalogue; available in hard copy and on-line.

In this example, for just the one eco-friendly purchase, Cardholder “One” was rewarded 3 times; first by GC Sponsor “A”, second by GC Sponsor “B” and third by GC Issuer. The first two rewards were likely proportional to the dollar value of the purchase. The third reward was proportional to that purchase's benefit to the environment.

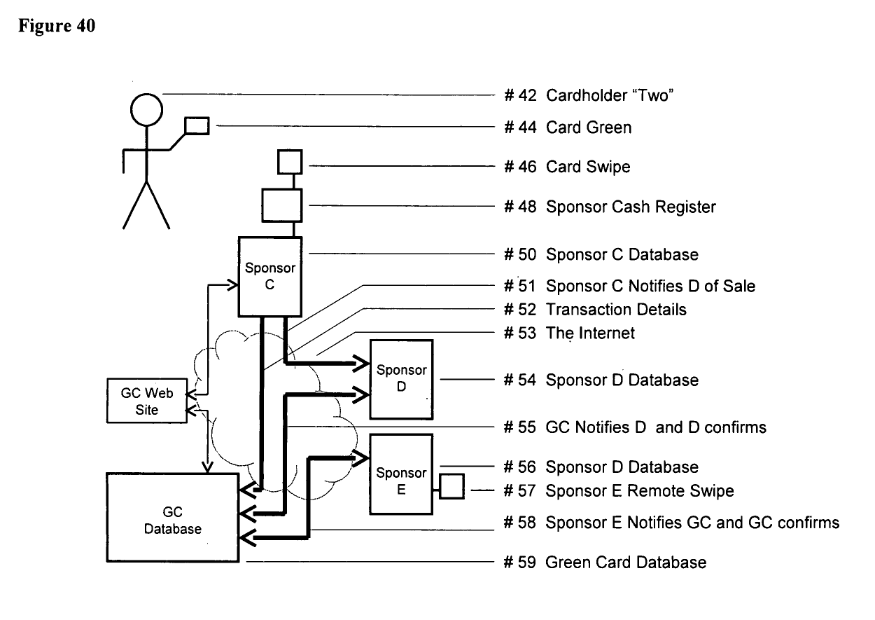

### As for FIG. 40: (Transaction Example Two)

Cardholder “Two” (#42) is an individual about to upgrade his inefficient wood burning fireplace. He shops for a natural gas fireplace insert in the hardware store of GC Sponsor “C”. GC Sponsor “C” is a distributor of insert manufacturer GC Sponsor “D”.

“Two” likes the features and price of the Sponsor “D” gas insert and will buy it if assured it will be installed by a certified gas line fitter who also offers Green Card points.

Sponsor “C” visits the GC web site for “listed” certified gas fitters in that area and finds GC Sponsor “E”. The sale is made, installation scheduled and the Green Card (#44) swiped (#46) at the cash register (#48) of Sponsor “C”. “Two” makes separate arrangements with Sponsor “E” to pay and ‘swipe’ at the time of installation on their remote unit (#57) and thus notify both Sponsor “E” database (#56) and also GC database (#59).

Transaction data goes from Sponsor “C” register (#48) to its database (#50) and via the internet (#53) to GC database (#59). “C” also notifies Sponsor “D” (#51), the insert maker's database (#54). Then, Sponsor “D” and the GC Database exchange notifications and confirmations (#59).

“Green points 1”, as set out by Sponsor “C”, are calculated and appropriately accorded (credit/debit) to the accounts of “Two” and Sponsor “C”; instantaneously. Additional “green points 1”, for insert delivery and installation costs, as set out by Sponsor “E” will be forthcoming as well, and appropriately accorded (credit/debit) to both “Two” and Sponsor “E” accounts. Then “green points 2”, as set out by Sponsor “D”, are appropriately accorded (credit/debit) to both “Two” and Sponsors “D” accounts; also instantaneously.

Then GC database (#59) calculates the impact of the more efficient fireplace on reduced emissions in “possible” carbon credits and places proportional “green points 3” in the reserve portion of the point savings account of “Two”. As previous, they will be released from ‘reserve’ upon their successful conversion from “possible” to “Certified” carbon credits and their subsequent sale.

In this example, for the one eco-friendly action, Cardholder “Two” is rewarded 4 times; once each by GC Sponsors “C”, “D” & “E” and then fourth, by Green Card Issuer.

Interestingly, depending on rulings by the local (Host Nation) Regulatory Bodies about this specific transaction, “Two” may be eligible for re-occurring credits. In which case, “Two” may receive still more “green points 3” directly from Green Card Issuer. (There's more on the subject of re-occurring credits in the next example.)

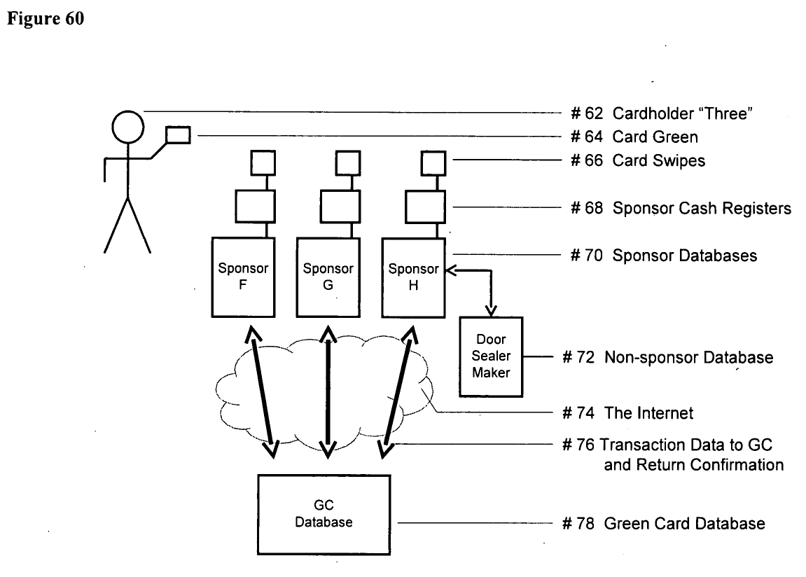

### As for FIG. 60: (Transaction Example Three)

Cardholder “Three” is a medium sized import/export business with a sizable but older warehouse. (And it's the business that is the enrolled the GC member.) Faced with ever increasing energy costs, “Three” undertakes 3 major efficiency improvements: a new roof top HVAC system, high efficiency (HE) overhead lighting and inflatable loading dock door sealers.

GC Sponsor “F” manufactures a suitable and competitively priced HVAC system. GC Sponsor “G” designs and distributes HE commercial & industrial lighting systems; also competitively priced. But at the time of these efficiency measures, the GC sponsor list had yet to include a maker or distributor of loading dock door sealers. However, the sponsor group already boasts several highly qualified mechanical engineering firms.

So, “Three” gives the HVAC contract to Sponsor “F”; the HE lighting contract to Sponsor “G”; and the door sealer installation contract to Sponsor “H”, one of those GC mechanical engineering concerns, to oversee (subcontract) the door sealer's (#72) own install crew. Thus, the entire efficiency upgrade is subject to GC rewards. Here's how they add up with just 3 card swipes and transaction details transmitted to the GC database in the same ways as previously described but now illustrated in FIG. 60.

“Green points 1”, as set out by Sponsor “H” are calculated and appropriately accorded (credit/debit) to the accounts of both “Three” and Sponsor “H”; instantaneously.

“Green points 1”, as set out by Sponsor “F” for installation costs are calculated and appropriately accorded (credit/debit) to the accounts of both “Three” and Sponsor “F”; instantaneously.

“Green points 2”, as set out by Sponsor “F” for the equipment are calculated and appropriately accorded (credit/debit) to the accounts of both “Three” and Sponsor “H”; instantaneously.

“Green points 1”, as set out by Sponsor “G” for lighting design & installation costs are calculated and appropriately accorded (credit/debit) to the accounts of both “Three” and Sponsor “G”; instantaneously.

“Green points 2”, as set out by Sponsor “G” for equipment are calculated and appropriately accorded (credit/debit) to the accounts of both “Three” and Sponsor “G”; instantaneously.

Then GC database calculates the combined impact of “Three's” 3-part efficiency project on reduced emissions in “possible” carbon credits and places the 3 proportional “green points 3” amounts in the reserve portion of the points account of “Three”. As previous, they will be released upon their successful conversion from “possible” to “Certified” and subsequent sale.

In this example, for the 3-part eco-friendly project, “Three” is rewarded 6 times already. And there are likely further points for “Three”. Based on the functional longevity of the energy upgrades put in place by “Three” there will be comparable emission reductions every year for several years to come. Therefore, the Regulatory Bodies are quite likely to allow this project “Re-occurring Carbon Credits” as defined in Kyoto. If such is the case, GC Issuer will be rewarding “Three” annually for as long as those “Credits” are deemed to “re-occur”.

There can be no discrimination by the Green Card Method in this matter. Both the rule book (Kyoto) and the referees (Regulatory Bodies) are outside of GC control. And the GC Process will always try to get its members “Re-occurring Credits”. And whenever successful in that attempt, the Cardholder will be proportionally rewarded. That's just part of the GC Process.

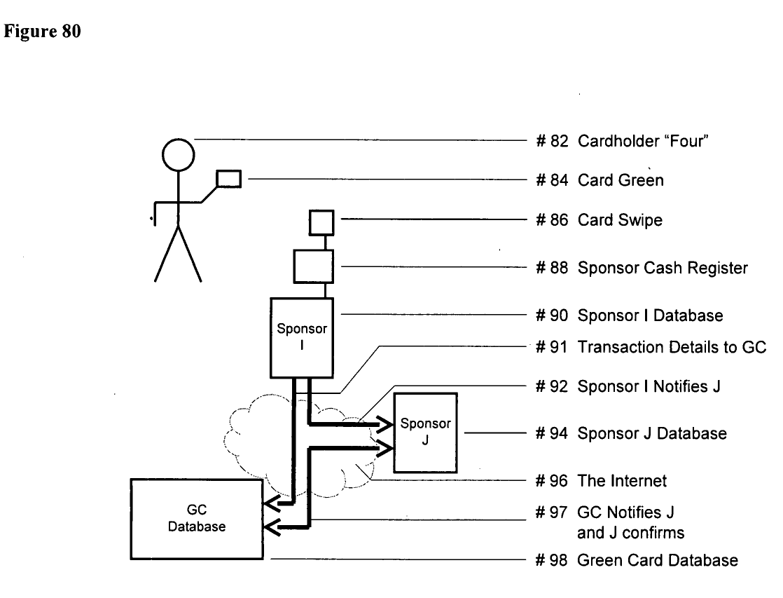

### As for FIG. 80: (Transaction Example Four)

Cardholder “Four” (#82) is an individual shopping at GC Sponsor “I”; an outlet of an HVAC manufacturer. “Four” intends to up-grade his 35 year old home heating and air conditioning system. Sponsor “I” designs and recommends an integrated system of a properly sized high efficiency (HE) furnace, a smaller, quieter air conditioner, a more effective humidifier, an electronic air filter and a sophisticated, individual room, programmable thermostat. “Four” is impressed and wants the total system but the costs exceed his anticipated budget. At least part of the project costs will have to go on one of his credit cards. Fortunately, GC Sponsor “J” is a major Credit Card company. So the choice of which credit card to use is easy for “Four”.

In fact, thanks to Sponsor “J”, there is a credit card function already imbedded into Green Card. It works with the cardholder's pre-existing PIN. So the whole, or any part of project that “Four” might choose, can be financed, almost with the same swipe. (Here we will assume “Four” elects to finance the entire project to gain that many more “green points”.)

At Sponsor “I” cash register (#88), “Four” swipes (#86) their Green Card (#84) which identifies them as a GC “points” collector with an approved line of credit from Sponsor “J”. At the swipe, “Four” adds his PIN when prompted to do so and the transaction is paid for. All pertinent transaction data (#91) is sent via the internet (#96) from the Sponsor “I” database (#90) to the GC database (#98).

“Green points 1 & 2”, as set out by Sponsor “I” are calculated and immediately accorded (credit/debit) to the accounts of both “Four” and Sponsor “I”.

Also, the GC database recognizes the use of its credit function. Sponsor “J” database (#94) is notified of the sale, also via the internet, by both Sponsor “I” (#92) and GC database (#97) and Sponsor “J” confirms the notification back to GC Database (#98).

Additional “green points 1”, as set out by Sponsor “J”, are appropriately accorded (credit/debit) to both Cardholder “Four” and Sponsor “J”; also instantaneously. Then, GC database (#98) calculates the impact of the new HVAC system on reduced carbon emissions, measured in CO2e. And proportional to those “possible” carbon credits, “Four” is accorded his reserve of “green points 3”.

In this example, for just the one eco-friendly system purchase, Cardholder “Four” was rewarded several times; probably twice by GC Sponsor “I”, once by GC Sponsor “J” and at least once by GC Issuer. We say “at least” because, given the predictable (“average”) lifespan of an HVAC system the efficiency project will most likely qualify for “re-occurring credits” as previously discussed, and if so, “Four” gets additional, proportional and annual “green points 3” from Issuer.

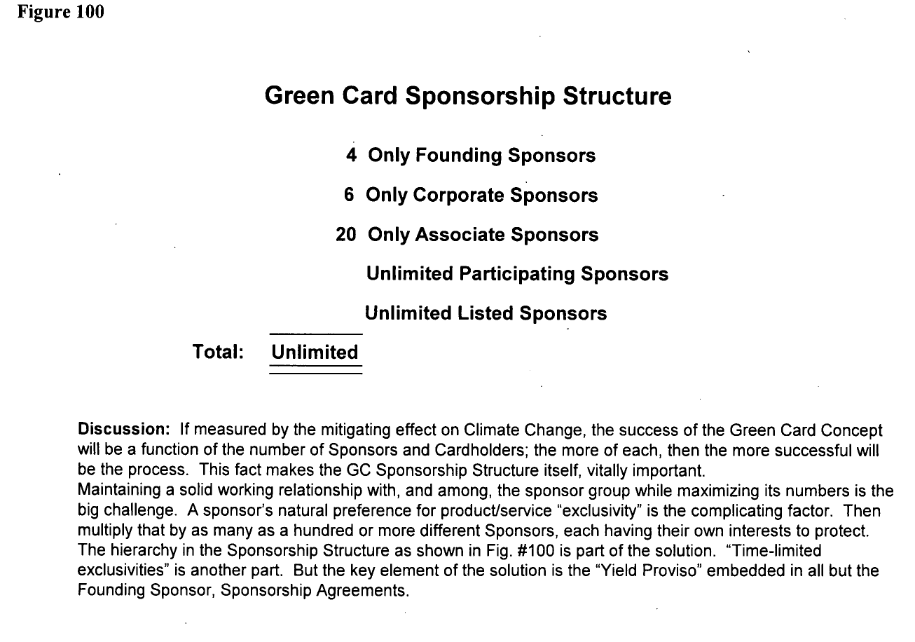

### As for FIG. 100: Sponsorship Structure

As shown in FIG. 100, there are five (5) multi-stationed levels of sponsorship in the GC Process. Each level of sponsorship has its own GC Sponsorship Agreement. Clearly stated in that Agreement are the Rights, Privileges and Obligations of that particular level of sponsorship. As might be expected, there is a hierarchy to the various levels as shown.

Founding Sponsors have the greatest Rights & Privileges but also accept the greatest Obligations. Corporate Sponsors have Rights & Privileges (R&P) very similar to those of the Founding Sponsors but if ever their R&P were to come in conflict with those of the Founders, then the R&P of the Corporate Sponsor will yield always to those of the Founder. Accordingly, the Obligations of the Corporate Sponsors are similar but less.

Associate Sponsors enjoy most, but not all, of the R&P of the 2 higher sponsorship levels, subject to the same kind of “Yield Proviso”. Accordingly, their Obligations are somewhat less. Participating Sponsors enjoy many, but not all, of the R&P of the 3 higher sponsorship levels, again subject to the “Yield Proviso”. Accordingly, their Obligations are considerably less. Listed Sponsors enjoy some, but not all, of the R&P of the higher 4 sponsorship levels, subject to the same kind of “Yield Proviso”. Accordingly, their Obligations are substantially less.

There are many reasons for this multi-level and multi-station sponsorship structure; not the least of which is to have sponsorship slots available for as many retailers of, and manufacturers of energy efficient products as possible. And the discussion on FIG. 100 mentions the most likely limiting factor to this objective: a natural sponsor desire for product &/or service “exclusivity”. Important: All sponsors will want “exclusivity” that will keep their competitors entirely out of the GC Process. But such demands are counter-current to our stated objective of maximizing the GC Process benefits to both the Cardholder and the Environment. For instance, it would be better for GC Cardholders and for the environment if all manufacturers of compact florescent bulbs could be part of the sponsorship group. This may or may not be possible. Or it may be possible to some degree.

Conflicted, with both a need to be as accommodating to prospective sponsors as possible, plus a need to involve as many different sponsors as possible, the GC Process developed its creative Sponsorship Structure and in its unique Sponsor Agreements. First, sponsor exclusivity, time related or otherwise, will be negotiable only in the top 3 levels.

Next, the GC Process calls for negotiated “time-limited” sponsor exclusivities whenever possible. This is not an absolutely new approach to encourage a greater number of sponsors. However, the next three (3) Sponsor Agreement inclusions are. The GC Process created the facilitating “Yield Proviso” as described above. The GC Process introduces “Sponsor Seniority Preference” within each level of the very purposefully designed Sponsorship Structure. This means, if ever existed a conflict of interest between sponsors of the same level, the more senior sponsor benefits from the “Yield Proviso”.

Further, the GC Process grants existing sponsors ‘first rights’ to take a higher sponsorship level before any potential competitor were to newly occupy that higher sponsorship level and thus be entitled to invoke the “Yield Proviso” over the interests of the more senior sponsor.

With its time-limited exclusivity clauses and its transparent use of both the “Yield Proviso” and the “Seniority Preference” the GC Process plans to achieve sponsor harmony and maximized sponsor numbers, all for the greatest possible benefit to Cardholder and to Environment.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

1. A method of tracking and redeeming carbon emission credits generated by a plurality of consumers comprising:
a) providing a carbon credits database of carbon emission credits for a plurality of goods and services, said carbon credits database comprising a list of said goods and services and a list of the carbon emission credits associated with each of the goods and services listed;
b) providing a customer loyalty card system to said plurality of consumers, said customer loyalty card system comprising a customer database including a plurality of customer records, each customer record including details of each customer and details of that customer's purchase of goods and services;
c) calculating a customer carbon credits total for each customer by summing the carbon emission credits for all of the goods and services purchased by said customer;
d) transferring ownership of all of the carbon credits accumulated by the customers' purchase of goods and services to a loyalty card operator, said loyalty card operator operating the carbon credits database and the customer loyalty card system, and
e) providing a customer reward to each of the customers in the customer loyalty card system, said customer reward being proportional to the customer carbon credits total.

2. The method of claim 1 wherein the customer reward is provided by the loyalty card operator.

3. The method of claim 2 further comprising the steps of providing a secondary rewards list of goods and services which qualify for a secondary reward, and providing a secondary reward to customers who purchase goods and services from the secondary rewards list.

4. The method of claim 3 wherein the secondary reward is proportional to a cumulative total of the goods and services from the secondary rewards list purchased by the customer.
